(19) United States
(12) Patent Application Publication
(10) Pub. No.: US 2018/0338406 A1
(43) Pub. Date: Nov. 29, 2018

(54) METHOD FOR CONTROLLING OPERATION OF A USER CONTROL TERMINAL OF AN AGRICULTURAL MACHINE AND AGRICULTURAL MACHINE

(71) Applicant: Kverneland Group Mechatronics B.V., Nieuw-Vennep (NL)

(72) Inventors: Jeroen Jacobs, Alphen aan den Rijn (NL); Sebastian Hagemann, Willebadessen (DE)

(21) Appl. No.: 15/987,055

(22) Filed: May 23, 2018

(30) Foreign Application Priority Data
May 24, 2017 (EP) 17172820.7

(51) Int. Cl. A01B 69/00; G06F 3/0482; G06F 3/0362; G06F 3/0488; G06F 3/0484; A01D 41/127; A01F 15/08

(52) U.S. Cl. CPC A01B 69/007; G06F 3/0482; G06F 3/0362; A01F 15/08; G06F 3/04847; A01D 41/127; G06F 3/04886

(57) ABSTRACT

An agricultural machine and method for controlling operation of a user control terminal of the machine are disclosed. The terminal receives user input through a control knob which operates in and is changeable upon a change request user input between first and second knob modes of operation. In the first knob mode, receipt through the control knob of a first function control user input causes a control unit to generate first function control signals and a functional element of an implement of the machine to operate according to the first function control signals, and receipt through the control knob of a second function control user input causes the control unit to generate second function control signals and the functional element to change operation according to the second function control signals. In the second knob mode, the terminal is prevented from receiving function control user input through the control knob.

### TECHNICAL FIELD

Embodiments of the present disclosure generally relate to agricultural apparatuses and methods thereof, and more specifically relate to a method for controlling operation of a user control terminal of an agricultural machine and an agricultural machine.

### BACKGROUND

For agricultural machines, a user control terminal may be provided in a tractor which provides a user interface for receiving user input, for example, for setting limits of operation parameters that are applied to control operation of one or more functional elements of an implement trailed by or carried on the tractor. For example, the so called IsoMatch Tellus (an ISOBUS Universal Terminal) may be provided as a user interface. The user is provided with a user menu on a display of the user control terminal. The user may provide input by engaging with a touch sensitive screen of the user control terminal. In addition or as an alternative, a joystick or a control knob may be provided for selecting menu items displayed on the display of the user control terminal.

Document EP 1 380 202 A1 discloses an automatic control system for a harvester. A shutter may be provided which can be switched between different positions, each position being assigned to a different operation control with regard to the harvester.

### SUMMARY

A method for controlling operation of a user control terminal of an agricultural machine and an agricultural machine for improving operability of the agricultural machine are disclosed herein.

The method for controlling operation of a user control terminal of an agricultural machine, may comprise: operating in a first knob mode of operation a control knob of a user control terminal provided on an agricultural machine having a tractor and an implement trailed by or carried on the tractor, in which the first knob mode of operation comprises receiving by the user control terminal a first function control user input through the control knob, in response to the receiving the first function control user input, generating first function control signals for a functional element of the implement in a control unit functionally connected to the functional element, operating the functional element according to the first function control signals, receiving by the user control terminal a second function control user input through the control knob, in response to the receiving the second function control user input, generating second function control signals for the functional element of the implement in the control unit, and changing operation of the functional element for operating the functional element according to the second function control signals. The method further may comprise receiving by the user control terminal a request user input for changing knob mode of operation for the control knob; and in response to the receiving, operating the control knob in a second knob mode of operation which comprises displaying a user menu on a display of the user control terminal, receiving a menu control user input through the control knob, and controlling selection of a menu item in the user menu displayed according to the menu control user input, and wherein the user control terminal is prevented from receiving function control user input through the control knob in the second knob mode of operation.

The agricultural machine, may comprise a tractor; an implement trailed by or carried on the tractor; a user control terminal on the tractor; and a control knob provided on the user control terminal for receiving user input through the control knob, wherein the user control terminal has the control knob configured to operate between a first knob mode of operation and a second mode of operation. The first knob mode of operation causes: the user control terminal to receive a first function control user input through the control knob; in response to receipt of the first function control user input through the control knob, a control unit to generate first function control signals for a functional element of the implement, the control unit being functionally connected to the functional element; the functional element to operate according to the first function control signals; the user control terminal to receive a second function control user input through the control knob; in response to receipt of the second function control user input through the control knob, the control unit to generate second function control signals for the functional element of the implement; the functional element to change operation according to the second function control signals; and the user control terminal to change from the first knob mode of operation to the second knob mode of operation upon receipt by the user control terminal of a request user input for the change of the knob mode of operation. The second knob mode of operation causes: a display of the user control terminal to display a user menu, the control knob to receive a menu control user input, and a menu item selected in the user menu displayed according to the menu control user input to be controlled, wherein the user control terminal is prevented from receiving function control user input through the control knob in the second knob mode of operation.

Other features, aspects, implementations, and advantages will become apparent from the description, the drawings, and embodiments disclosed herein.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic representation of a control system of an agricultural machine or system provided with a tractor and an implement trailed by or carried on the tractor;

FIG. 2 is a schematic representation of a user control terminal having a panel of a control knob provided with a wheel rotatable received on the user control terminal;

FIG. 3 is a schematic representation of the panel from FIG. 2, the control knob being operated in a second knob mode of operation;

FIG. 4 is a schematic representation of a panel of a user controlled terminal having a control knob provided with a graphical knob element on a display of the user control terminal, the control knob being operated in a first knob mode of operation; and

FIG. 5 is a schematic representation of the panel from FIG. 4, the control knob being operated in a second knob mode of operation.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

According to an aspect, a method for controlling operation of a user control terminal of an agricultural machine is disclosed. The method may comprise providing an agricultural machine having a tractor and an implement trailed by or carried on the tractor with a user controlled terminal on the tractor, the user controlled terminal being configured to receive user input through a control knob. The control knob is operated in a first knob mode of operation, which may comprise: receiving a first function control user input through the control knob; in response to the receiving the user input, generating first function control signals for a functional element of the implement in a control unit functionally connected to the functional element; and operating the functional element according to the first function control signals; receiving a second function control user input through the control knob; in response to the receiving the user input, generating second function control signals for the functional element of the implement in the control unit; and changing operation of the functional element for operating the functional element according to the second function control signals. A request user input for changing knob mode of operation for the control knob is received. In response to the receiving the request user input, the control knob is operated in a second knob mode operation, the user controlled terminal being prevented from receiving function control user input through the control knob in the second knob mode operation. The operating of the control knob in the second knob mode of operation may comprise: displaying a user menu on a display of the user control terminal; receiving a menu control user input through the control knob; and controlling selection of a menu item in the user menu displayed according to the menu control user input.

According to another aspect, an agricultural machine is disclosed, which may comprise a tractor, an implement trailed by or carried on the tractor, a user controlled terminal on the tractor and a control knob provided on the user control terminal for receiving user input through the control knob. The user control terminal has the control knob configured to operate in a first knob mode of operation, which may comprise: receiving a first function control user input through the control knob; in response to the receiving the user input, generating first function control signals for a functional element of the implement in a control unit functionally connected to the functional element; operating the functional element according to the first function control signals; receiving a second function control user input through the control knob; in response to the receiving the user input, generating second function control signals for the functional element of the implement in the control unit; and changing operation of the functional element for operating the functional element according to the second function control signals. Further, the user controlled terminal is configured to receive a request user input for changing knob mode of operation for the control knob and, in response to the receiving the request user input, operate the control knob in a second knob mode of operation in which the user controlled terminal is prevented from receiving function control user input through the control knob while in the second knob mode of operation. Operating the control knob in the second knob mode operation may comprise: displaying a user menu on a display of the user control terminal; receiving a menu control user input through the control knob; and controlling selection of a menu item in the user menu displayed according to the menu control user input.

The various embodiments disclosed allow for switching the control knob function between direct and instant operation control of the functional element of the implement and menu item selections which do not instantly changing operation of the functional element. In an alternative embodiment, in the second knob mode of operation, operation parameter settings may be received through the control knob, such settings being applied to the functional element at a later stage, therefore not providing for direct or real-time control of the functional element of the implement.

Various embodiments disclosed may provide for implementing, by the control knob in the first knob mode of operation, a control element for the operation of the functional element of the implement. By engaging with the control knob in the first knob mode of operation the user may be allowed to instantly and actually control the functional operation state of the functional element of the implement. In direct response to the user engaging with the control knob, the functional element is operated according to present (changing) control signals generated instantly or in real-time in response to the different function control user inputs.

A changing operation may comprise changing an operation position of the functional element from the first operation position in the first knob mode operation to a second operation position in the second knob mode of operation. For example, the first and second operation position may be a lifted and a lowered operation position. As an alternative or in addition, the first and second operation positions may refer to a proximal or distal position of the functional element with regard to another element of the implement, for example, a support frame.

The changing of the operation may comprise changing an operation position of the functional element from a first operation position in the first knob mode of operation to a second operation position in the second knob mode of operation.

The changing of the operation position may comprise changing the operation position of the functional element from a first rotational position in the first mode of operation to a second rotational position in the second mode of operation. For example, a conveyer or a cutting element of a mower may be moved in response to the user input through the control knob in the first knob mode of operation from a first to a second rotational position.

The changing of the operation position may comprise changing a steering position of a functional steering element from a first steering position in the first knob mode of operation to a second steering position in the second knob mode of operation. Thereby, the user is provided with the option for steering the functional steering element of the implement by engaging with the control knob. Rotating the control knob will turn the functional steering element into different steering positions. In this embodiment, the control knob may implement a steering wheel rotation of which applies rotation of the functional steering element in real-time or an instant manner.

The changing of the operation may comprise changing an operation position of the functional implement from a first operation speed in the first knob mode operation to a second operation speed in the second knob mode of operation. By rotating the control knob the speed of a rotational movement of the functional element is changed, for example, a speed of rotation (rotational speed). For example, the speed of rotation of the functional element in operation may be increased or lowered in response to the user engaging with the control knob, thereby, rotating the control knob, in the first knob mode of operation. In an alternative, the speed of rotation of a rake element of a rake machine may be changed by rotating the control knob, thereby, receiving functional control user input through the control knob on the user control terminal in the tractor.

With regard to the method, the providing of the user control terminal may comprise the control knob with a wheel rotatable received on the user control terminal, and the receiving of the user input may comprise determining different rotational positions of the wheel for receiving the first and second control user input.

With regard to the method, the providing of the user control terminal may comprise providing the control knob with a graphical knob element on the display of the user control terminal, and the receiving of the user input comprises detecting display user input for receiving the first and second function control user input, the display user input engaging with the graphical knob element. Changing the graphical element may refer to rotating the graphical element displayed on the display of the user control terminal in response to the user input. The user input, for example, may be received by the user touching a touch sensitive display or engaging with a joystick and/or a mouse input for rotating the graphical knob element on the display.

The generating may comprise the first function control signals for the functional element indicating a first value of an operation parameter and the second function control signals for the functional element indicating a second value of an operation parameter, wherein a value difference between the first and second value of the operation parameter is proportional to a position difference between a first rotational position and a second rotational position of the control knob assigned to the first and the second function control user input, respectively. The operation parameter, for example, may refer to speed, height and/or distance. The position difference between the first and the second rotational position may be a difference in the degree of rotation.

The generating may comprise generating at least one of the first and second function control signals in a central in a control unit connected to the user control terminal, and transmitting at least one of the first and second function control signals from the central control unit to a local control unit on the implement through a data bus, the local control unit connected to the functional and configured to control operation of the functional element.

The preventing may comprise preventing the user control terminal comprises at least one of preventing generation of the first and second function control signals in the control unit, and preventing transmission of the first and second function control signals from the central control unit to the local control unit. The preventing may comprise interrupting the data bus connection to the local control unit assigned to the functional element. The preventing may comprise setting an operation flag in an operating system in the user control terminal, the operation flag indicating the second mode of operation not allowing or preventing receiving function control user input through the control knob.

The operating of the functional implement may comprise, in response to the receiving the first and second function control user input, real-time operating the functional element according to the first and second function control signals. A real-time switching may apply for switching of the operation of the functional element from the first to the second functional control signals.

The operating of the functional element may comprise operating a functional implement element from the following group: rake element, conveyor element, pick-up element, cutting element, wrapping element, lifting element, steering element, spraying element, seeding element, and chamber element of a baler. The functional element may be provided on an implement selected from the following group: mower, baler, sprayer, rake, seeder, and loader wagon.

The method, in at least one of the first knob mode of operation and the second knob mode of operation, may comprise limiting a rotation of the control knob to a predefined degree of rotation. For example, in the first mode of operation, the limiting of the control knob rotation will limit operation of the functional element. For example, an extent of a relocation of the functional element, e.g. a distance of relocation, may be limited. Thereby, damage to the functional element may be prevented. Such damage may be caused if the functional element, in response to the user input through the control knob, would be moved to a position outside operation limits of the functional element. The operation limits of the functional element may be assigned to the limits of predefined degree of rotation. For example, a maximum distance of movement of the functional element may be assigned to the predefined degree of rotation. The limiting of the rotation of the control knob may be applied to the graphical knob element, for example, by providing proper software control. With regard to the “hardware” control knob, for example, the rotatable wheel, some mechanical and/or electro-mechanic rotation control may be provided which is limiting the rotation of the wheel to the predefined degree of rotation which may be adjustable by the user.

With regard to the agricultural machine, the alternative embodiments disclosed regarding the method for controlling operation of the user controlled terminal above may apply mutatis mutandis.

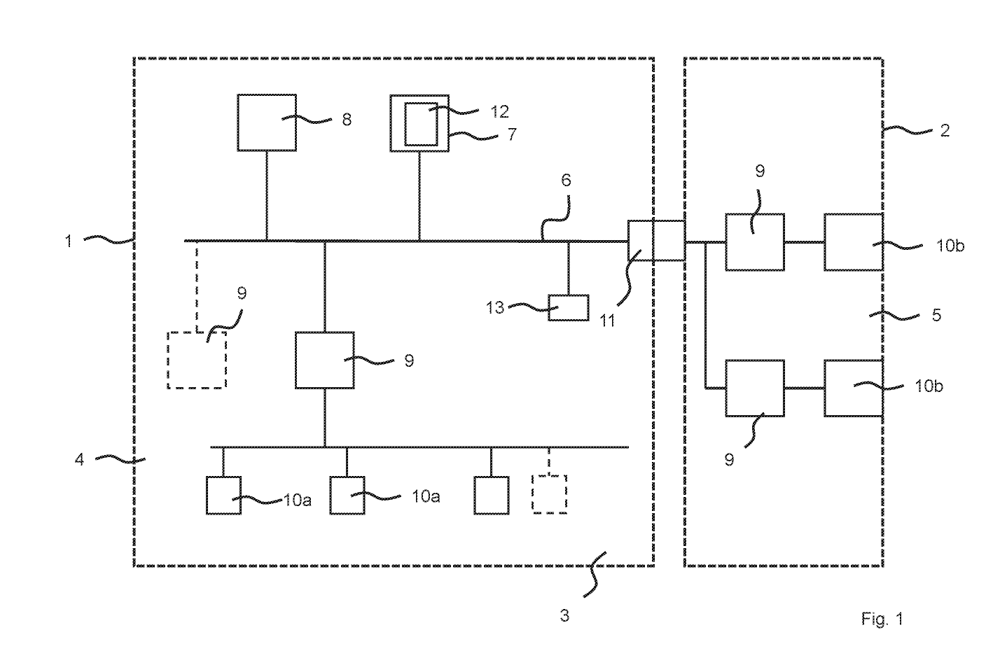

Turning now to the illustrated embodiments of the figures, FIG. 1 shows a schematic representation of an agricultural machine or system having a tractor 1 and an implement 2 trailed by or carried on the tractor 1. An agricultural machine control network 3 provides for an electronic control system of the agricultural machine or system. The agricultural machine control network 3 comprises a tractor control network 4 and an implement control network 5. The agricultural machine control network 3 is having a data bus 6 to which, according to the embodiment shown, a user control terminal 7, a task controller 8, and a plurality of electronic control units 9 are connected. Each of the electronic control units 9 is assigned to a functional element 10a, 10b provided in the tractor 1 and the implement 2, respectively. In an alternative embodiment, the electronic control units 9 connected to the user control terminal 7 through the data bus may only be applied to the functional element(s) 10b of the implement 2, but not to the functional element(s) 10a of the tractor.

With regard to the implement 2, the functional elements 10b may also be to as working or functional unit. Through the data bus 6 electronic data may be transmitted between the components, units, modules or elements connected to the data bus 6. The electronic control system of the agricultural machine control network 3 may implement the ISO 11783 standard, preferably the ISO 11783-11 standard.

The data bus 6 is provided with a plug connector 11 connecting the tractor control network 4 and the implement control network 5.

The user or operator control terminal 7 is provided with a terminal display 12 and provides for user control and user display. Further, the user control terminal 7 is provided with a processor unit comprising a processor and a memory element connected to the processor. Multiple software applications implemented on the user terminal may be running simultaneously.

Through the user control terminal 7 user input may be received for controlling the functional elements 10a, 10b of the agricultural machine or system. Also, through the terminal display 12 operation information may be displayed to the user.

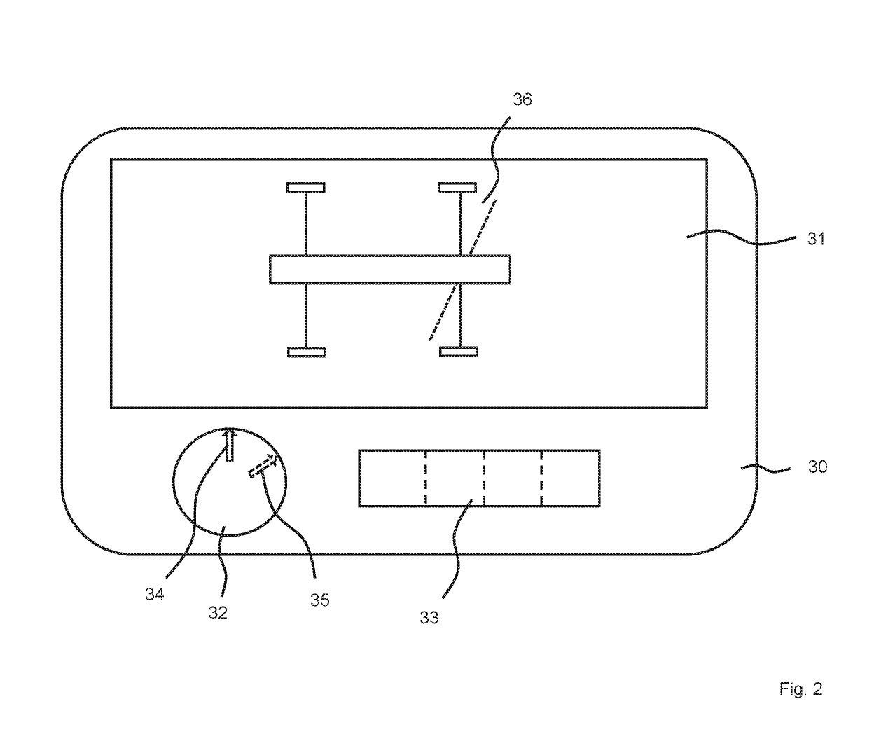

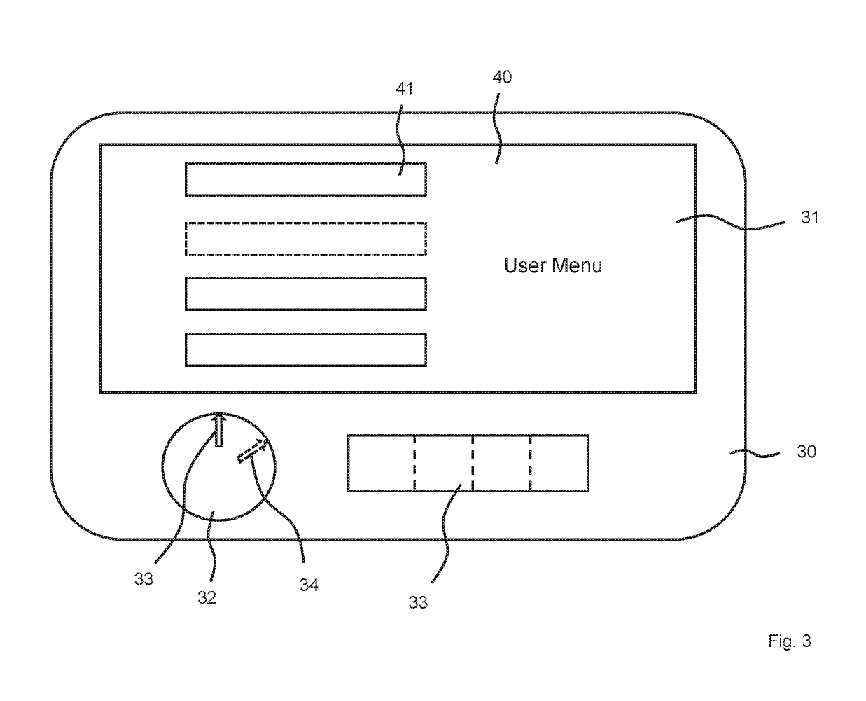

Referring to FIGS. 2 and 3, a schematic representation of a panel 30 of the user control terminal 7 is shown. The user control terminal 7 is having a display field 31 provided on the display 12 and a control knob 32. Further, input elements 33 are provided on the panel 30 of the user control terminal 7 which, for example, may be provided by a plurality of push buttons.

The control knob 32 is to be operated in a first and a second knob mode of operation, shown in FIGS. 2 and 3, respectively. In the first knob mode of operation, according to FIG. 2, a first and a second function control user input are received in the user control terminal 30 through the control knob 32, wherein the control knob 32 is in different rotational positions 34, 35 depicted in FIG. 2. In response to the receiving of the first and second function control user input, first and second function control signals are generated for the functional element 10b of the implement 2, and the functional element 10b is operated according to the first function control signals and, after receiving the second function control user input through the control knob 32, according to the second function control signals. For example, a rotation speed of the functional element 10b is changed in response to receiving the second function control user input, wherein the rotation speed may be lowered or increased. In an alternative embodiment, the control knob 32 in the first knob mode of operation may implement direct steering of a steering element of the implement 2, such as the functional element 10b. The steering element is controlled by rotating the control knob 32 of the user control terminal 7 on the tractor 1. According to FIG. 2, a present steering position may be indicated by a graphical representation 36 on the display field 31.

In response to a request user input for changing knob mode of operation for the control knob 32, the operation of the control knob 32 may switch to a second knob mode of operation shown in FIG. 3. Such request user input may be received through the control knob 32 and/or, for example, the further input elements 33. In the second knob mode of operation, the user control terminal 7 is prevented from receiving function control user input for the functional element(s) 10b of the implement 2 through the control knob 32. Therefore, direct or real-time control of the functional element(s) 10b through the control knob 32 is not allowed (blocked) in the second knob mode of operation. In a similar way, if the user control terminal 7 is connected to the functional elements 10a of the tractor 1, the user control terminal 7 may be prevented from receiving function control user input for the functional element(s) 10a of the tractor 1 through the control knob 32 in the second knob mode of operation.

In the second knob mode of operation, the control knob 32 provides for different functionality, namely handling or guiding through a user menu 40 (see FIG. 3) displayed on the display field 31 of the display 12 of the user control terminal 7. Menu control user input may be received through the control knob 32 for controlling selection of a menu item 41 of the user menu 40 displayed. In the second knob mode of operation, the control knob 32 allows the user to handle or manipulate the user menu displayed.

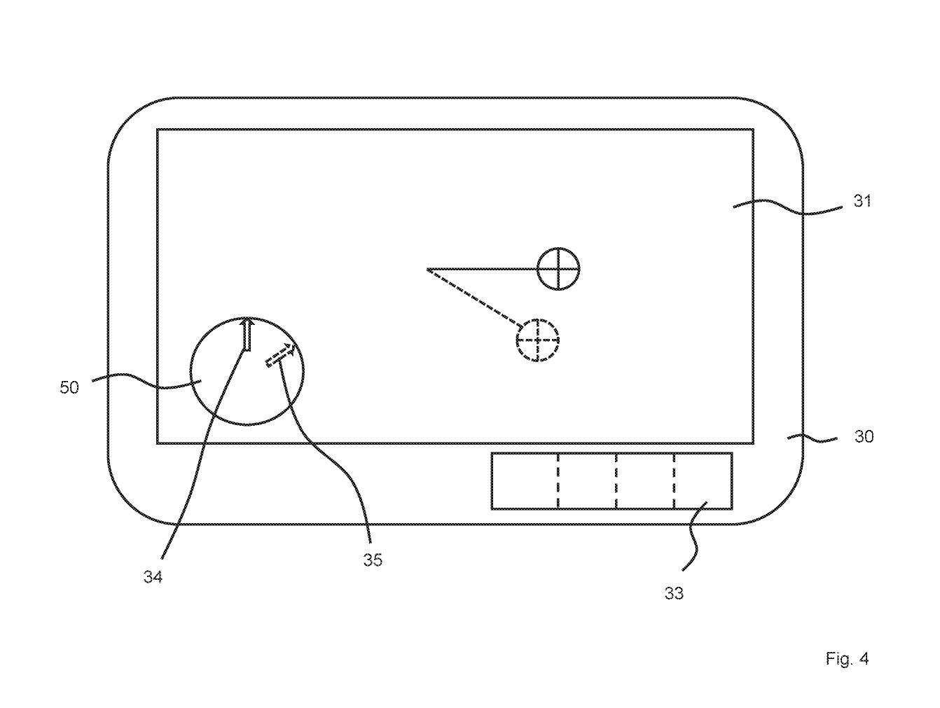

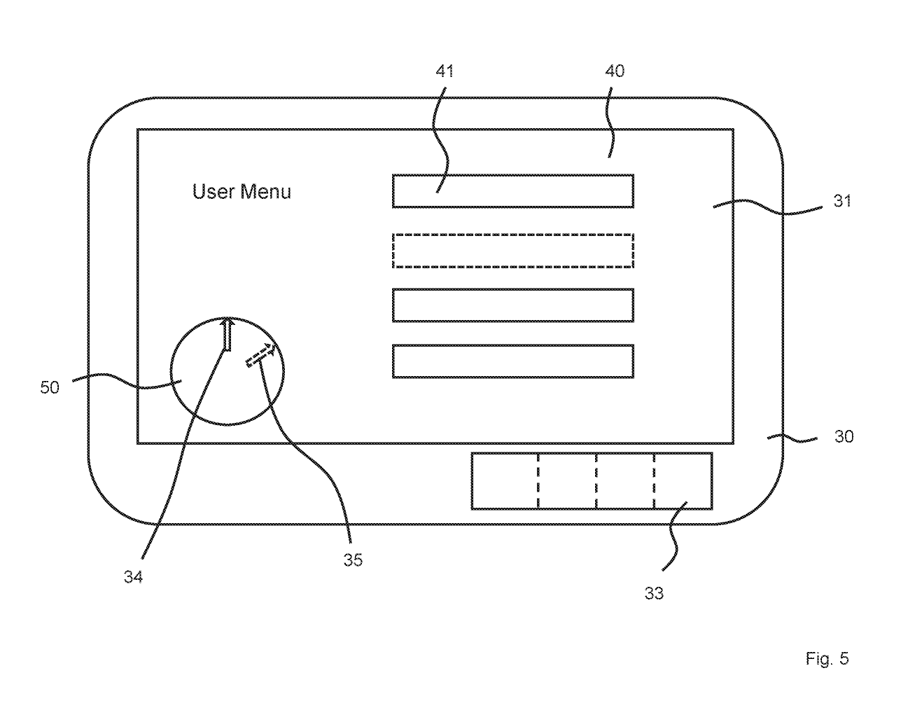

Referring to FIGS. 4 and 5, alternative embodiments are depicted in which the control knob 32 is implemented or provided by a graphical knob element 50 on the display field 31 of the user control terminal 7. The operation described above with regard to the rotatable wheel may apply to the graphical knob element 50 mutatis mutandis. The graphical knob element 50 may be rotated into the different rotational positions 34, 35 by the user for providing function control user input in the first knob mode of operation as described above. Changing of the graphical knob element 50, for example by rotating the graphical knob element 50 on the display field 31 may be caused the user by touching the display field 31 which may be provided as a touch sensitive display. As an alternative, the further input elements 33 may allow for user input for changing the graphical knob element 50 for function control user input. Similarly, according to FIG. 5 the user may engage with the graphical knob element 50 for providing menu control user input in the second knob mode of operation applied to the control knob 32 represented by the graphical knob element 50.

The features disclosed in this specification, the figures and/or the claims may be material for the realization of the various embodiments, taken in isolation or in various combinations thereof.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A method for controlling operation of a user control terminal of an agricultural machine, comprising:
operating in a first knob mode of operation a control knob of a user control terminal provided on an agricultural machine having a tractor and an implement trailed by or carried on the tractor, in which the first knob mode of operation comprises:
receiving by the user control terminal a first function control user input through the control knob;
in response to the receiving the first function control user input, generating first function control signals for a functional element of the implement in a control unit functionally connected to the functional element;
operating the functional element according to the first function control signals;
receiving by the user control terminal a second function control user input through the control knob;
in response to the receiving the second function control user input, generating second function control signals for the functional element of the implement in the control unit; and
changing operation of the functional element for operating the functional element according to the second function control signals;
receiving by the user control terminal a request user input for changing knob mode of operation for the control knob; and
in response to the receiving, operating the control knob in a second knob mode of operation which comprises:
displaying a user menu on a display of the user control terminal;
receiving a menu control user input through the control knob; and
controlling selection of a menu item in the user menu displayed according to the menu control user input, and
wherein the user control terminal is prevented from receiving function control user input through the control knob in the second knob mode of operation.

2. The method according to claim 1, wherein the changing operation comprises changing an operation position of the functional element from a first operation position in the first knob mode of operation to a second operation position in the second knob mode of operation.

3. The method according to claim 2, wherein the changing the operation position comprises changing the operation position of the functional element from a first rotational position in the first mode of operation to a second rotational position in the second mode of operation.

4. The method according to claim 1, wherein the changing the operation position comprises changing a steering position of a functional steering element from a first steering position in the first knob mode of operation to a second steering position in the second knob mode of operation.

5. The method according to claim 1, wherein the changing operation comprises changing an operation position of the functional implement from a first operation speed in the first knob mode operation to a second operation speed in the second knob mode of operation.

6. The method according to claim 1, wherein:
the providing of the user control terminal comprises providing the control knob with a wheel rotatable received on the user control terminal; and
the receiving of the user input comprises determining different rotational positions of the wheel for receiving the first and second function control user input.

7. The method according to claim 1, wherein:
the providing of the user control terminal comprises providing the control knob with a graphical knob element on the display of the user control terminal; and
the receiving of the user input comprises detecting display user input for receiving the first and second function control user input, the display user input engaging with the graphical knob element.

8. The method according to claim 1, wherein the generating comprises:
the first function control signals for the functional element indicating a first value of an operation parameter; and
the second function control signals for the functional element indicating a second value of an operation parameter,
wherein a value difference between the first and second value of the operation parameter is proportional to a position difference between a first rotational position and a second rotational position of the control knob assigned to the first and the second function control user input, respectively.

9. The method according to claim 1, wherein the generating comprises:
generating at least one of the first and second function control signals in a central control unit connected to the user control terminal; and
transmitting at least one of the first and second function control signals from the central control unit to a local control unit on the implement through a data bus, the local control unit connected to the functional and configured to control operation of the functional element.

10. The method according to claim 1, wherein the preventing the user control terminal from receiving function control user input through the control knob in the second knob mode of operation comprises at least one of:
preventing generation of the first and second function control signals in the control unit; and
preventing transmission of the first and second function control signals from the central control unit to the local control unit.

11. The method according to claim 1, wherein the operating of the functional implement comprises, in response to the receiving the first and second function control user input, operating in real-time the functional element according to the first and second function control signals.

12. The method according to claim 1, wherein the operating of the functional element comprises operating a functional implement element from the following group: rake element, conveyor element, pick-up element, cutting element, wrapping element, lifting element, steering element, spraying element, seeding element, and chamber element of a baler.

13. The method according to claim 1, wherein the user control terminal comprises a central user control terminal on the tractor, and said method comprises receiving user input for setting implement modes of operation for the implement and tractor modes of operation for the tractor via the central user control terminal.

14. The method according to claim 1, further comprising, in at least one of the first knob mode of operation and the second knob mode of operation, limiting a rotation of the control knob to a predefined degree of rotation.

15. An agricultural machine, comprising:
a tractor;
an implement trailed by or carried on the tractor;
a user control terminal on the tractor; and
a control knob provided on the user control terminal for receiving user input through the control knob, wherein the user control terminal has the control knob configured to operate between a first knob mode of operation and a second mode of operation, wherein:
the first knob mode of operation causes:
the user control terminal to receive a first function control user input through the control knob;
in response to receipt of the first function control user input through the control knob, a control unit to generate first function control signals for a functional element of the implement, the control unit being functionally connected to the functional element;
the functional element to operate according to the first function control signals;
the user control terminal to receive a second function control user input through the control knob;
in response to receipt of the second function control user input through the control knob, the control unit to generate second function control signals for the functional element of the implement;
the functional element to change operation according to the second function control signals; and
the user control terminal to change from the first knob mode of operation to the second knob mode of operation upon receipt by the user control terminal of a request user input for the change of the knob mode of operation; and
the second knob mode of operation causes:
a display of the user control terminal to display a user menu;
the control knob to receive a menu control user input; and
a menu item selected in the user menu displayed according to the menu control user input to be controlled,
wherein the user control terminal is prevented from receiving function control user input through the control knob in the second knob mode of operation.
